(19) United States
(12) Patent Application Publication
(10) Pub. No.: US 2026/0270729 A1
(43) Pub. Date: Sep. 10, 2026

(54) SYSTEM

(71) Applicant: SOFTBANK GROUP CORP., Tokyo (JP)

(72) Inventor: Kunihiko AZUMA, Tokyo (JP)

(73) Assignee: SOFTBANK GROUP CORP., Tokyo (JP)

(21) Appl. No.: 19/557,245

(22) Filed: Mar. 5, 2026

Related U.S. Application Data
(60) Provisional application No. 63/767,975, filed on Mar. 6, 2025.

(51) Int. Cl. H04W 24/02; H04L 41/0659; H04L 41/16; H04W 24/04

(52) U.S. Cl. CPC H04W 24/02; H04L 41/0661; H04L 41/16; H04W 24/04

(57) ABSTRACT

A system that utilizes AI to optimize communication networks is provided. It analyzes big data such as geographic information, demographics, urban planning, and demand forecasts to achieve optimal network equipment placement. The geographic information acquisition unit analyzes terrain characteristics, and the demographic collection unit forecasts communication demand by region. The urban planning analysis unit considers future development plans, and the demand forecasting unit predicts peak demand based on historical data. The monitoring unit monitors equipment status in real time, and the early warning detection unit detects signs of impending failure. The self-diagnostic unit and automatic repair unit respond swiftly to minor faults, minimizing communication service interruptions. Generative AI supports data analysis, enabling optimal network construction. This achieves the provision of efficient, high-quality communication services.

### CROSS-REFERENCE TO RELATED APPLICATION

This application claims priority under 35 U.S.C. § 119 to U.S. Provisional Patent Application No. 63/767,975, filed on Mar. 6, 2025, the entire contents of which are incorporated herein by reference.

### BACKGROUND

### Technical Field

The present disclosure relates to a system.

### Related Art

Japanese Patent Application Publication Laid-Open (JP-A) No. 2022-180282 discloses a persona chatbot control method performed by at least one processor, comprising: a step of receiving a user utterance; a step of adding to the user utterance a prompt containing a description of the chatbot's persona and related instructions; a step of encoding the prompt; and a step of inputting the encoded prompt into a language model to generate a chatbot utterance in response to the user utterance.

### SUMMARY

A system and method for efficient operation of communication networks and the provision of high-quality services is disclosed. Specifically, the disclosure aims to solve the following problems.

First, in the equipment deployment of communication networks, optimization considering diverse factors such as geographical conditions, population dynamics, and urban planning is required. Conventional methods often analyzed these factors individually, making overall optimization difficult. The disclosure utilizes AI to comprehensively analyze this big data, achieving optimal equipment deployment to improve communication quality and reduce costs.

Next, there exists the risk of service interruptions due to failures or aging of communication equipment. Conventional systems typically respond only after a failure occurs, often making service interruptions unavoidable. The disclosure enables proactive countermeasures by continuously monitoring equipment status and detecting early signs of failure or aging. This minimizes communication service interruptions and enhances stability.

Furthermore, flexible responses to fluctuations in communication demand are required. Particularly, if appropriate equipment upgrades are not performed for peak demand, there is a risk of degraded communication quality. The disclosure enables the provision of consistently high-quality communication services by performing precise demand forecasting and adjusting equipment based on these forecasts.

As described above, the disclosure aims to solve challenges such as optimizing equipment placement, early detection of fault precursors, and flexible response to demand fluctuations, thereby achieving efficient operation of communication networks and the provision of high-quality services.

As a means for solving the problems, the present invention provides a system having the following configuration.

First, it includes a geographic information acquisition unit that acquires geographic information. This unit identifies optimal installation locations for base stations and relay stations by performing detailed analysis of terrain characteristics and infrastructure conditions. This maximizes the utilization of radio wave propagation characteristics and achieves efficient network coverage.

Next, it includes a demographic data collection unit that collects demographic data. This unit analyzes population density, age groups, and lifestyle patterns by region. This enables precise prediction of communication demand, taking into account population fluctuations over time.

Furthermore, it includes an urban planning analysis unit that analyzes urban planning information. This unit plans equipment deployment anticipating future population shifts and demand changes, taking into account upcoming urban development and infrastructure improvement plans. This enables network optimization from a long-term perspective.

It also includes a demand forecasting unit that analyzes past communication data and trends to predict peak communication demand. Based on this, it plans necessary bandwidth, and equipment upgrades to maintain communication service quality.

Furthermore, it includes a monitoring unit that monitors the status of base station equipment. This unit collects data such as temperature, humidity, power consumption, and operational status in real time from sensors installed on each piece of equipment. This enables the early detection of equipment abnormalities or signs of impending failure.

Additionally, it includes a fault prediction unit that detects signs of impending failure or aging. This unit analyzes the collected data to detect abnormal patterns. This enables proactive countermeasures to be taken, minimizing interruptions to communication services.

Finally, it includes a self-diagnostic unit that performs equipment self-diagnosis and an automatic repair unit that performs automatic repairs during failures. These units perform remote reboots or configuration changes for minor failures, quickly resolving issues. This enables improved stability of the communication network.

Through the above configuration, the present invention achieves efficient operation of the communication network and provides high-quality services.

### BRIEF DESCRIPTION OF THE DRAWING

FIG. 1 is a conceptual diagram showing an example configuration of a data processing system according to the first embodiment.

FIG. 2 is a conceptual diagram showing an example of the main functions of the data processing device and smart device according to the first embodiment.

FIG. 3 is a conceptual diagram showing an example configuration of a data processing system according to a second embodiment.

FIG. 4 is a conceptual diagram showing an example of the main functions of the data processing device and smart glasses according to the second embodiment.

FIG. 5 is a conceptual diagram showing an example configuration of a data processing system according to a third embodiment.

FIG. 6 is a conceptual diagram showing an example of the main functions of the data processing device and headset-type terminal according to the third embodiment.

FIG. 7 is a conceptual diagram showing an example configuration of a data processing system according to the fourth embodiment.

FIG. 8 is a conceptual diagram showing an example of the main functions of the data processing device and robot according to the fourth embodiment.

FIG. 9 shows an emotion map onto which multiple emotions are mapped.

FIG. 10 shows an emotion map onto which multiple emotions are mapped.

### DETAILED DESCRIPTION

The following describes an example embodiment of a system according to the present disclosure with reference to the accompanying drawings.

First, the terminology used in the following description is explained.

In the following embodiments, a processor (hereinafter simply referred to as a "processor") may be a single arithmetic unit or a combination of multiple arithmetic units. Furthermore, the processor may be a single type of arithmetic unit or a combination of multiple types of arithmetic units.

Examples of processing units include a CPU (Central Processing Unit), a GPU (Graphics Processing Unit), a GPGPU (General-Purpose Computing on Graphics Processing Units), an APU (Accelerated Processing Unit), and the like.

In the following embodiments, signed RAM (Random Access Memory) is a memory where information is temporarily stored and is used by the processor as working memory.

In the following embodiments, signed storage refers to one or more non-volatile storage devices that store various programs and various parameters, etc. Examples of non-volatile storage devices include flash memory (SSD (Solid State Drive)), magnetic disks (e.g., hard disk), or magnetic tape.

In the following embodiment, the coded communication I/F is an interface including a communication processor and an antenna, etc. The communication interface governs communication between multiple computers. Examples of communication standards applicable to the communication interface include wireless communication standards such as 5G (5th Generation Mobile Communication System), Wi-Fi (registered trademark), or Bluetooth (registered trademark).

In the following embodiments, "A and/or B" is synonymous with "at least one of A and B." That is, "A and/or B" means it may be only A, only B, or a combination of A and B. Furthermore, in this specification, when three or more matters are expressed by connecting them with "and/or," the same concept applies as for "A and/or B".

### FIRST EMBODIMENT

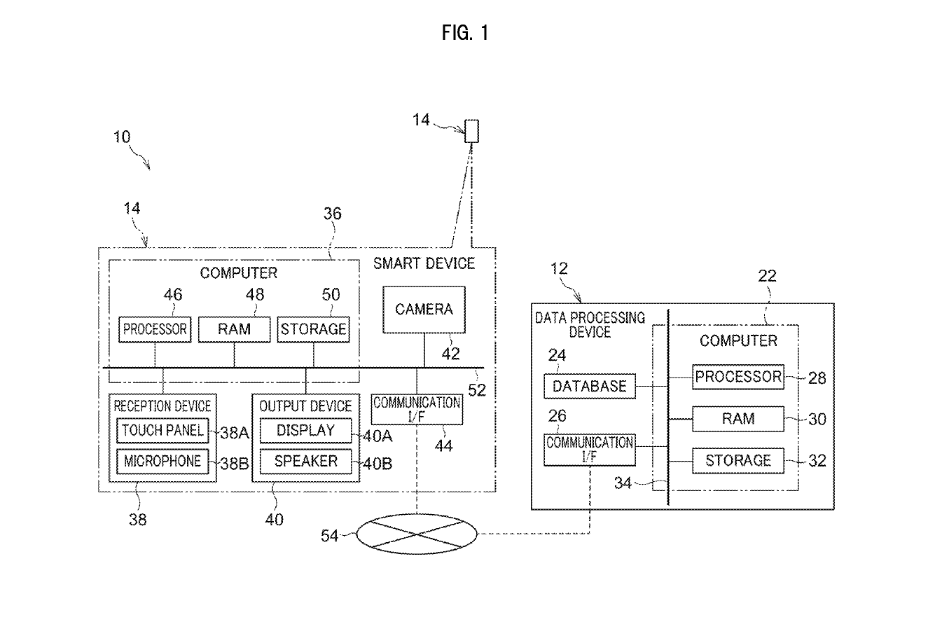

FIG. 1 shows an example configuration of the data processing system 10 according to the first embodiment.

As shown in FIG. 1, the data processing system 10 includes a data processing device 12 and a smart device 14. An example of the data processing device 12 is a server.

The data processing device 12 includes a computer 22, a database 24, and a communication I/F 26. The computer 22 is an example of a "computer" according to the technology of the present disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 include a WAN (Wide Area Network) and/or a LAN (Local Area Network).

The smart device 14 includes a computer 36, a reception device 38, an output device 40, a camera 42, and a communication I/F 44. The computer 36 includes a processor 46, RAM 48, and storage 50. The processor 46, RAM 48, and storage 50 are connected to a bus 52. The reception device 38, output device 40, and camera 42 are also connected to the bus 52. The reception device 38, output device 40, and camera 42 are also connected to the bus 52.

The reception device 38 includes a touch panel 38A and a microphone 38B, among other components, and receives user input. The touch panel 38A receives user input via contact with an input device (e.g., a pen or finger) by detecting such contact. The microphone 38B receives voice-based user input by detecting the user's voice. The control unit 46A transmits data indicating the user input received via the touch panel 38A and microphone 38B to the data processing unit 12. Within the data processing unit 12, the specific processing unit 290 acquires the data indicating the user input.

The output device 40 includes a display 40A and a speaker 40B, among others. It presents data to the user 20 by outputting it in a form perceptible to the user 20 (e.g., voice and/or text). The display 40A displays visual information such as text and images according to instructions from the processor 46. The speaker 40B outputs voice according to instructions from the processor 46. Camera 42 is a compact digital camera equipped with an optical system including a lens, aperture, and shutter, and an imaging element such as a CMOS (Complementary Metal-Oxide-Semiconductor) image sensor or a CCD (Charge Coupled Device) image sensor.

The communication interface 44 is connected to the network 54. The communication interfaces 44 and 26 manage the exchange of various information between processor 46 and processor 28 via network 54.

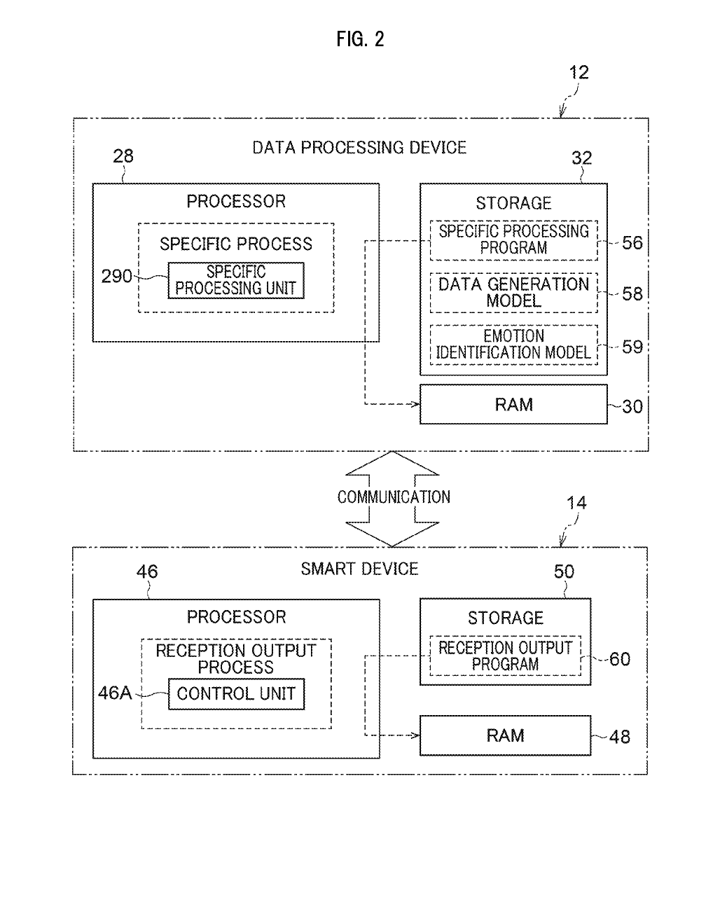

FIG. 2 shows an example of the main functions of the data processing device 12 and the smart device 14.

As shown in FIG. 2, specific processing is performed by processor 28 in data processing device 12. Specific processing program 56 is stored in storage 32. Specific processing program 56 is an example of a "program" related to the technology of this disclosure. The processor 28 reads the specific processing program 56 from the storage 32 and executes the read specific processing program 56 on the RAM 30. The specific processing is realized by the processor 28 operating as a specific processing unit 290 according to the specific processing program 56 executed on the RAM 30.

Storage 32 stores a data generation model 58 and an emotion identification model 59. The data generation model 58 and emotion identification model 59 are used by specific processing unit 290. Specific processing unit 290 can estimate a user's emotion using emotion identification model 59 and perform specific processing using the user's emotion. The emotion estimation function (emotion identification function) using the emotion identification model 59 performs various estimations and predictions concerning the user's emotion, including estimation and prediction of the user's emotion, but is not limited to such examples. Furthermore, estimation and prediction of emotion also includes, for example, analysis (parsing) of emotion.

The smart device 14 performs reception output processing via the processor 46. The storage 50 stores the reception output program 60. The reception output program 60 is used in conjunction with the specific processing program 56 by the data processing system 10. The processor 46 reads the reception output program 60 from the storage 50 and executes the read reception output program 60 on the RAM 48. The specific processing is performed by the processor 46 operating as a control unit 46A according to the specific processing program 60 executed on the RAM 48. Note that the smart device 14 may also have data generation models and emotion identification models similar to the data generation model 58 and emotion identification model 59, and may perform processing similar to that of the specific processing unit 290 using these models. The reception output processing is realized by the processor 46 operating as the control unit 46A according to the reception output program 60 executed on the RAM 48.

Other devices besides the data processing device 12 may also have the data generation model 58. For example, a server device (e.g., a generation server) may have the data generation model 58. In this case, the data processing device 12 communicates with the server device having the data generation model 58 to obtain processing results (such as prediction results) obtained using the data generation model 58. Furthermore, the data processing device 12 may be the server device itself, or it may be a terminal device owned by a user (e.g., a mobile phone, robot, home appliance, etc.). Next, an example of processing by the data processing system 10 according to the first embodiment will be described.

### Example 1

The flow of the specific processing in Example 1 is described below. The components of the system described below are implemented by the data processing device 12 and the smart device 14. The data processing device 12 is referred to as the "server," and the smart device 14 is referred to as the "terminal."

### Implementation Examples for Carrying Out the Invention

The embodiment for implementing the present invention will now be described in further detail. This system is realized using a server and a terminal, with each component performing its respective role to optimize the communication network and enhance its stability.

First, the geographic information acquisition unit is implemented on the server. This unit acquires data concerning terrain characteristics and infrastructure conditions from geographic information systems, satellite data, and map databases. For example, in mountainous areas where radio wave reflection and obstruction are likely to occur, it performs detailed analysis of terrain elevation differences and vegetation density to determine the optimal placement of base stations considering radio wave propagation characteristics. Furthermore, in urban areas where high-rise buildings may cause signal blockage, it plans placements that minimize signal obstruction by considering building heights and configurations. Additionally, it considers existing road and railway layouts, predicts communication demand in high-traffic areas, and deploys equipment appropriately.

Next, the population statistics collection unit is also implemented on the server. This unit collects population statistics data provided by government agencies and statistical institutions, analyzing population density, age groups, and lifestyle patterns by region. For example, in business districts with high daytime populations, it predicts increased daytime communication demand, while in residential areas with high nighttime populations, it plans equipment placement considering nighttime communication needs. Furthermore, since tourist areas experience population fluctuations based on seasons and events, demand forecasts are made aligned with tourist seasons and event schedules to plan appropriate equipment upgrades.

Furthermore, the Urban Planning Analysis Department is implemented on the server. This department analyzes urban planning information provided by municipalities and urban planning agencies, incorporating future urban development and infrastructure improvement plans. For instance, in areas with new residential development plans, it plans base station additions anticipating future population growth. Similarly, when new commercial or public facility construction is planned, it forecasts the accompanying increase in communication demand and implements appropriate equipment placement. Furthermore, for urban redevelopment projects, equipment plans are formulated to accommodate the renewal and expansion of existing infrastructure.

The demand forecasting unit is also implemented on the server. This unit analyzes historical communication data and trends to predict peak communication demand. For example, in areas hosting specific events, it anticipates temporary surges in communication demand and adjusts equipment to secure the necessary bandwidth. It also considers seasonal demand fluctuations; planning equipment upgrades to handle summer and winter demand peaks. Furthermore, it forecasts demand changes driven by social trends and the adoption of new technologies, formulating equipment plans to respond flexibly.

The monitoring unit is implemented on terminals. These terminals are installed at each base station facility and collect data such as temperature, humidity, power consumption, and operational status in real time. For example, if the base station temperature becomes abnormally high, a cooling system failure can be suspected, allowing repairs to be arranged in advance. Furthermore, if humidity changes significantly, equipment deterioration can be detected early, enabling preventive maintenance. Furthermore, if power consumption is higher than normal, it enables the early detection of equipment abnormalities and allows for a swift response.

The anomaly detection unit is implemented on the server. This unit analyzes data transmitted from the monitoring unit to detect abnormal patterns or signs of impending failure. For example, if power consumption is higher than normal, it can detect equipment abnormalities early and respond promptly. Furthermore, if abnormalities are observed in operating conditions, it can suspect software bugs or hardware failures and make swift corrections. Additionally, it can perform integrated analysis of data from multiple sensors to detect signs of complex abnormalities.

The self-diagnostic unit and automatic repair unit are implemented on the server. These units perform remote reboots or configuration changes for minor faults, resolving issues quickly. For example, if a communication failure occurs due to a software bug, the terminal automatically reboots upon instruction from the server, resolving the problem. Similarly, if communication quality degrades due to configuration issues, the settings are automatically corrected upon instruction from the server, restoring communication quality. Furthermore, even for minor hardware failures, remote diagnosis and repair are possible, enabling rapid problem resolution.

As described above, the present invention uses a server and terminals to comprehensively analyze geographic information, demographic data, urban planning data, and demand forecast data, thereby achieving optimal network equipment placement. Furthermore, by continuously monitoring equipment status and detecting early signs of failure or aging, it minimizes communication service interruptions and enhances stability. This enables efficient operation of the communication network and the provision of high-quality services.

### System Configuration

The system according to this embodiment comprises a geographic information acquisition unit, a demographic data collection unit, an urban planning analysis unit, a demand forecasting unit, a monitoring unit, a precursor detection unit, a self-diagnostic unit, and an automatic repair unit.

The geographic information acquisition unit acquires data concerning terrain characteristics and infrastructure conditions from geographic information systems, satellite data, and map databases. This unit analyzes terrain data for mountainous areas and urban areas to determine the optimal placement of base stations, considering radio wave propagation characteristics. For example, in mountainous areas, it performs detailed analysis of terrain elevation differences and vegetation density to plan placements that minimize radio wave reflection and obstruction. In urban areas, it determines placements that avoid radio wave shielding by considering the layout of high-rise buildings. Furthermore, it predicts communication demand in high-traffic areas by considering the layout of existing roads and railways, enabling appropriate equipment placement. Additionally, it collects data to respond to changes in geographical obstacles and natural environments, enabling real-time placement adjustments.

The Population Statistics Collection Department gathers population statistics data provided by government agencies and statistical bodies, analyzing regional population density, age demographics, and lifestyle patterns. This department predicts higher daytime communication demand in business districts with large daytime populations and plans equipment placement considering nighttime communication demand in residential areas with larger nighttime populations. For example, in tourist areas where population fluctuates with seasons and events, demand forecasts are made for peak tourist seasons and event periods to plan appropriate capacity enhancements. It also forecasts changes in communication demand by considering regional economic activities and social trends. Furthermore, it analyzes long-term demographic shifts and incorporates them into future facility planning.

The Urban Planning Analysis Department analyzes urban planning information provided by municipalities and urban planning agencies, incorporating future urban development and infrastructure improvement plans. In areas with new residential development plans, this department plans base station expansions anticipating future population growth. For instance, when new commercial or public facility construction is planned, it forecasts the accompanying increase in communication demand and implements appropriate equipment placement. Furthermore, for urban redevelopment projects, it formulates equipment plans to accommodate the renewal or expansion of existing infrastructure. Additionally, it forecasts demand changes associated with urban transportation plans and public transit system expansions, developing equipment plans to respond flexibly.

The Demand Forecasting Department analyzes historical communication data and trends to predict peak communication demand. This department anticipates temporary surges in communication demand in areas hosting specific events and adjusts equipment to secure the necessary bandwidth. For example, it plans facility enhancements to handle seasonal demand peaks in summer and winter. It also forecasts demand shifts driven by social trends and new technology adoption, developing flexible facility plans. Furthermore, it performs real-time data analysis to respond to fluctuating demand, enabling rapid facility adjustments.

The monitoring unit is installed at each base station facility and collects data such as temperature, humidity, power consumption, and operational status in real time. This unit can suspect cooling system failure if the base station temperature becomes abnormally high and arrange repairs in advance. For example, if humidity changes significantly, it can detect equipment degradation early and perform preventive maintenance. Furthermore, if power consumption is higher than normal, it can detect equipment abnormalities early and respond quickly. Additionally, if operational status abnormalities are detected, it suspects software bugs or hardware failures and performs rapid corrections.

The premonition detection unit analyzes data transmitted from the monitoring unit to detect abnormal patterns or signs of impending failure. This unit enables the early detection of equipment abnormalities and rapid response when power consumption is higher than normal. For example, if abnormal operating conditions are observed, it can suspect software bugs or hardware failures and implement swift corrections. It can also perform integrated analysis of data from multiple sensors to detect signs of complex abnormalities. Furthermore, it can detect abnormal changes by comparing with historical data and take preventive measures.

The self-diagnostic unit and automatic repair unit resolve minor faults quickly by performing remote reboots or configuration changes. If a communication failure occurs due to a software bug, the terminal automatically reboots upon instruction from the server to resolve the issue. For instance, if communication quality degrades due to configuration issues, the settings are automatically corrected upon server instruction to restore communication quality. Furthermore, it enables rapid resolution of minor hardware faults through remote diagnosis and repair. Additionally, the self-diagnostic function periodically checks equipment status, enabling the early detection and response to potential issues.

Specific examples of prompt sentences to be fed into the generative AI required for implementing the present invention include: "Propose a method for planning optimal base station placement based on data acquired from a geographic information system" or "Develop an algorithm to predict regional communication demand using demographic data." This enables the AI to efficiently analyze data and support optimal network construction.

### Implementation Steps

### Step 1: Acquisition and Analysis of Geographic Information

The geographic information acquisition unit obtains data on terrain characteristics and infrastructure conditions from geographic information systems, satellite data, and map databases. In mountainous areas, it analyzes terrain elevation differences and vegetation density in detail to plan placements that minimize signal reflection and obstruction. In urban areas, it determines placements that avoid radio wave shielding by considering the layout of high-rise buildings. It predicts communication demand in high-traffic areas by considering the layout of existing roads and railways, and deploys equipment appropriately. It collects data to respond to geographical obstacles and changes in the natural environment, enabling real-time placement adjustments.

### Step 2: Collection and Analysis of Demographic Data

The demographic collection unit gathers population statistics provided by government agencies and statistical bodies, analyzing regional population density, age demographics, and lifestyle patterns. In business districts with high daytime populations, anticipate increased daytime communication demand; in residential areas with high nighttime populations, plan equipment placement considering nighttime communication needs. In tourist areas, where population fluctuates with seasons and events, demand forecasts are made aligned with tourist seasons and event schedules to plan appropriate equipment upgrades. Changes in communication demand are forecasted by considering regional economic activities and social trends.

### Step 3: Analysis of Urban Planning Information

The Urban Planning Analysis Department analyzes urban planning information provided by municipalities and urban planning agencies, incorporating future urban development and infrastructure improvement plans. In areas with new residential development plans, base station expansion is planned anticipating future population growth. When new commercial or public facility construction is planned, the accompanying increase in communication demand is forecasted to enable appropriate equipment placement. For urban redevelopment projects, equipment plans are formulated to accommodate the renewal or expansion of existing infrastructure.

### Step 4: Implementing Demand Forecasting

The demand forecasting unit analyzes historical communication data and trends to predict peak communication demand. In areas hosting specific events, it anticipates temporary surges in communication demand and adjusts equipment to secure necessary bandwidth. It considers seasonal demand fluctuations and plans equipment upgrades to handle summer and winter demand peaks. It forecasts demand changes driven by social trends and the adoption of new technologies, formulating equipment plans to respond flexibly.

### Step 5: Equipment Status Monitoring

Monitoring units installed at each base station collect real-time data on temperature, humidity, power consumption, and operational status. If a base station's temperature becomes abnormally high, a cooling system failure is suspected, allowing repairs to be arranged proactively. Significant humidity changes enable early detection of equipment degradation, facilitating preventive maintenance. If power consumption is higher than normal, it enables early detection of equipment abnormalities and rapid response. If operational status abnormalities are detected, it suspects software bugs or hardware failures and enables swift corrective action.

### Step 6: Detection of Anomaly Precursors

The anomaly detection unit analyzes data transmitted from the monitoring unit to detect abnormal patterns or signs of impending failure. If power consumption is higher than normal, it enables early detection of equipment abnormalities and rapid response. If operational status abnormalities are observed, it suspects software bugs or hardware failures and performs prompt corrections. By integrating and analyzing data from multiple sensors, it can detect signs of complex abnormalities. By comparing with historical data, it can detect abnormal changes and enable the implementation of preventive measures.

### Step 7: Self-Diagnosis and Automatic Repair

The self-diagnostic and auto-repair units perform remote reboots or configuration changes for minor faults, resolving issues quickly. If communication failures occur due to software bugs, the terminal automatically reboots upon server instruction to resolve the issue. If communication quality degrades due to configuration issues, settings are automatically corrected upon server instruction to restore quality. Even for minor hardware failures, remote diagnosis and repair enable rapid problem resolution. The self-diagnostic function periodically checks equipment status, enabling the early detection and response to potential issues.

### Step 8: Data Analysis Using Generative AI

Use generative AI to analyze various types of data. In this step, provide the generative AI with prompts such as: "Propose a method to plan optimal base station placement based on data obtained from the Geographic Information System" or "Develop an algorithm to predict regional communication demand using demographic data." This enables the AI to efficiently analyze data and support optimal network construction. The AI integrates and analyzes geographic information, demographics, urban planning, and demand forecasting data to provide insights for achieving optimal network equipment placement.

### Specific Use Cases

For example, when optimizing a communication network in a major metropolitan area, the system of the present invention functions as follows. The geographic information acquisition unit collects topographical data for the entire metropolitan area and analyzes the layout of high-rise buildings and the structure of the subway network within the urban area. This enables the determination of the optimal placement of base stations, considering radio wave propagation characteristics. Specifically, around subway stations, it plans the placement of dedicated underground relay stations to meet communication demand underground.

The population statistics collection unit gathers data on population density and age demographics for each district within the metropolitan area, predicting communication demand in business districts with concentrated daytime populations and residential areas with high nighttime populations. For example, in business districts, anticipating increased daytime communication demand, equipment is enhanced to handle peak periods. In residential areas, considering nighttime communication demand, equipment is deployed to provide stable communication services.

The Urban Planning Analysis Department analyzes urban development plans provided by local governments to forecast increased communication demand accompanying new commercial facilities or residential area development. For example, if a new shopping mall construction plan exists, it plans base station additions anticipating increased communication demand in the surrounding area. For redevelopment projects, it formulates equipment plans to accommodate updates to existing infrastructure.

The Demand Forecasting Department predicts temporary spikes in communication demand in areas hosting specific events based on historical communication data. For example, when a large-scale sporting event is held, it deploys temporary relay stations near the venue to handle peak demand and secure the necessary bandwidth. It also plans equipment upgrades to handle seasonal demand fluctuations, such as summer and winter peaks.

The monitoring unit is installed at each base station facility and collects real-time data such as temperature, humidity, power consumption, and operational status. For example, if a base station's temperature becomes abnormally high, it suspects a cooling system failure and can arrange repairs in advance. If humidity changes significantly, it detects equipment degradation early and performs preventive maintenance.

The Precursor Detection Unit analyzes data transmitted from the Monitoring Unit to detect abnormal patterns or signs of impending failure. For example, if power consumption is higher than normal, it can detect equipment abnormalities early and enable rapid response. If operational status abnormalities are detected, it suspects software bugs or hardware failures and performs swift corrections.

The self-diagnostic unit and automatic repair unit resolve minor faults quickly by performing remote reboots or configuration changes. For example, if a communication failure occurs due to a software bug, the terminal automatically reboots upon instruction from the server to resolve the issue. If communication quality degrades due to configuration issues, the settings are automatically corrected upon instruction from the server to restore communication quality.

In the step utilizing generative AI, prompt sentences such as "Perform geographic information analysis to plan optimal base station placement in metropolitan areas" or "Develop an algorithm to predict communication demand in specific regions based on demographic data" are fed to the generative AI. This enables the AI to efficiently analyze data and support optimal network construction. The AI integrates and analyzes geographic information, demographic data, urban planning data, and demand forecast data to provide insights for achieving optimal network equipment placement.

### Application Example 1

The flow of specific processing in Application Example 1 is described below. The components of the system described below are implemented by the data processing device 12 and the smart device 14. The data processing device 12 is referred to as the "server," and the smart device 14 is referred to as the "terminal."

### Implementation Examples for the Present Invention

The embodiment for implementing the present invention is described in further detail below. This system aims to optimize city-wide infrastructure and services by integrating multiple data sources, thereby enhancing urban functionality and improving residents' quality of life.

First, the geographic information acquisition unit collects and analyzes the city's topographical data and infrastructure information. This unit identifies the city's road network, public transportation layout, and the locations of parks and public facilities. For example, it identifies intersections prone to traffic congestion and optimizes signal control. Specifically, it analyzes traffic flow during specific time periods using data from traffic sensors and cameras to adjust signal timing. Furthermore, when designing new roads or public transportation routes, it proposes optimal layouts considering topography and existing infrastructure. For instance, by designing barrier-free routes that account for elevation differences, it provides transportation infrastructure accessible to all residents. Additionally, for urban expansion plans, it provides data to achieve efficient land use while considering geographical constraints. For example, it formulates development plans that avoid areas prone to flood risk.

Next, the Population Dynamics Analysis Unit analyzes population density, age demographics, and lifestyle patterns by region. This unit identifies residents' movement patterns and daily activity times to forecast demand for public services. For instance, in areas with a high elderly population, it optimizes the placement of nursing care facilities and medical institutions to provide necessary services promptly. Specifically, it monitors the operational status of medical institutions and vacancy rates at nursing care facilities in real time and establishes systems for rapid emergency response. In areas with many families raising children, it optimizes the placement of childcare facilities and schools to enhance the educational environment. For instance, plans are formulated to install pedestrian bridges over high-traffic roads to ensure the safety of school routes. Furthermore, data is provided to plan the expansion or contraction of public infrastructure in response to population growth or decline. For example, anticipating population increases due to new residential area development, infrastructure for water supply, sewage, and electricity is strengthened.

The Traffic Data Analysis Department monitors traffic conditions in real time and forecasts traffic volume fluctuations. This department utilizes data from traffic sensors and cameras to optimize public transportation schedules. For example, it increases the frequency of buses and trains during commuting hours to alleviate traffic congestion. Specifically, based on passenger volume data, it increases the number of departures during peak demand periods. Additionally, it establishes temporary traffic routes during events to ensure smooth pedestrian flow. For instance, during large-scale sporting events, it plans traffic restrictions around venues and operates shuttle buses. Furthermore, it devises preventive measures to reduce the risk of traffic accidents and improve traffic safety. Examples include installing road signs at accident-prone locations and reviewing speed limits.

The Energy Management Department collects citywide energy consumption data and develops plans to achieve efficient energy use. This department focuses on introducing renewable energy and shifting energy consumption away from peak times. For example, it develops plans to introduce solar and wind power generation, aiming for energy self-sufficiency. Specifically, it analyzes regional sunlight hours and wind condition data to propose optimal placement of power generation facilities. Furthermore, during peak energy consumption periods, it provides incentives to level demand and promote efficient energy use. For example, it implements programs offering electricity rate discounts to households that reduce power consumption during peak times. Additionally, it provides data to support the design and renovation of energy-efficient buildings. For instance, it promotes the use of highly insulating building materials to enhance building energy efficiency.

The Environmental Monitoring Department monitors urban environmental data in real time and implements measures for environmental protection. This department detects air pollution and noise issues early and takes appropriate countermeasures. For example, it plans the installation of air purifiers and the expansion of green spaces to improve the urban environment. Specifically, it analyzes PM 2.5 and NOx concentration data, identifies pollution sources, and implements countermeasures. It also provides environmental information to residents to promote environmental awareness. For example, it offers real-time environmental data via smartphone apps, encouraging residents to reconsider their own actions. Furthermore, it supports urban planning to address climate change, aiming to realize sustainable cities. For instance, it strengthens drainage systems in flood-prone areas and mitigates the heat island effect through greening.

In this way, the present invention can optimize the infrastructure and services of the entire city, improving residents' quality of life. This system supports the sustainable development of cities and provides efficient and comfortable urban living.

### System Configuration

The system according to this embodiment comprises a geographic information acquisition unit, a population dynamics analysis unit, a traffic data analysis unit, an energy management unit, and an environmental monitoring unit. The geographic information acquisition unit collects and analyzes urban topography data and infrastructure information. This unit identifies the city's road network, public transportation layout, and the locations of parks and public facilities. For example, it identifies intersections prone to traffic congestion and optimizes signal control. Specifically, it analyzes traffic flow during specific time periods using data from traffic sensors and cameras, and adjusts signal timing. It also proposes optimal layouts for new roads and public transit routes, considering topography and existing infrastructure. For instance, by designing barrier-free routes that account for elevation differences, it provides accessible transportation infrastructure for all residents. Furthermore, it provides data to achieve efficient land use in urban expansion plans by considering geographical constraints. For example, it helps formulate development plans that avoid flood-prone areas.

The Population Dynamics Analysis Unit possesses functions to analyze population density, age demographics, and lifestyle patterns by region. This unit identifies residents' movement patterns and daily activity times to forecast demand for public services. For instance, in areas with a high elderly population, it optimizes the placement of nursing care facilities and medical institutions to provide necessary services promptly. Specifically, it monitors the operational status of medical institutions and vacancy rates at nursing care facilities in real time, establishing a system capable of rapid response during emergencies. Furthermore, in areas with many child-rearing families, it optimizes the placement of childcare facilities and schools to enhance the educational environment. For instance, it plans the installation of pedestrian bridges over high-traffic roads to ensure the safety of school routes. Additionally, it provides data to plan the expansion or contraction of public infrastructure in response to population growth or decline. For example, anticipating population increases due to new residential area development, it strengthens water supply, sewage, and power supply infrastructure.

The Traffic Data Analysis Department monitors traffic conditions in real time and possesses the capability to predict fluctuations in traffic volume. This department utilizes data from traffic sensors and cameras to optimize public transportation schedules. For example, it increases the frequency of buses and trains during commuting hours to alleviate traffic congestion. Specifically, based on passenger count data, it increases the number of departures during peak demand periods. Additionally, it establishes temporary traffic routes during events to ensure smooth pedestrian flow. For instance, during large-scale sporting events, it plans traffic restrictions around venues and operates shuttle buses. Furthermore, it devises preventive measures to reduce the risk of traffic accidents and improve traffic safety. Examples include installing road signs at accident-prone locations and reviewing speed limits.

The Energy Management Department collects citywide energy consumption data and develops plans to achieve efficient energy use. This department focuses on introducing renewable energy and shifting energy consumption away from peak times. For example, it develops plans to introduce solar and wind power generation, aiming for energy self-sufficiency. Specifically, it analyzes regional sunlight hours and wind condition data to propose optimal placement of power generation facilities. Furthermore, during peak energy consumption periods, it provides incentives to level demand and promote efficient energy use. For example, it implements programs offering electricity rate discounts to households that reduce power consumption during peak times. Additionally, it provides data to support the design and retrofitting of energy-efficient buildings. For instance, it promotes the use of highly insulating building materials to improve a building's energy efficiency.

The Environmental Monitoring Department monitors urban environmental data in real time and implements measures for environmental protection. This department detects air pollution and noise issues early and takes appropriate countermeasures. For example, it plans the installation of air purifiers and the expansion of green spaces to improve the urban environment. Specifically, it analyzes PM 2.5 and NOx concentration data, identifies pollution sources, and implements countermeasures. It also provides environmental information to residents to promote environmental awareness. For example, it offers real-time environmental data via smartphone apps, encouraging residents to reconsider their own behaviors. Furthermore, it supports urban planning to address climate change, aiming to realize sustainable cities. Examples include strengthening drainage systems in flood-risk areas and mitigating the heat island effect through greening.

Specific examples of prompt sentences to feed into the generative AI required to implement the present invention include: "Propose optimal public transportation routes based on city traffic data" or "Analyze energy consumption data and formulate a plan for introducing renewable energy." This enables the AI to efficiently analyze data and support optimal urban planning. The AI integrates and analyzes geographic information, demographic data, transportation data, energy consumption data, and environmental data to provide insights for optimizing urban functions.

### Implementation Steps

### Step 1: Geographic Information Collection and Analysis

The geographic information acquisition unit collects and analyzes urban topography data and infrastructure information. This step identifies the city's road network, public transportation layout, and the locations of parks and public facilities. It pinpoints intersections prone to traffic congestion and optimizes signal control. Specifically, it analyzes traffic flow during specific time periods using data from traffic sensors and cameras to adjust signal timing. Furthermore, when designing new roads or public transit routes, it proposes optimal layouts considering topography and existing infrastructure. By designing barrier-free routes that account for elevation differences, it provides transportation infrastructure accessible to all residents. For urban expansion plans, it provides data to achieve efficient land use while considering geographical constraints.

### Step 2: Population Dynamics Analysis

The Population Dynamics Analysis Unit analyzes population density, age demographics, and lifestyle patterns by region. This step identifies resident movement patterns and daily activity times to forecast demand for public services. In areas with high elderly populations, it optimizes the placement of nursing care facilities and medical institutions to provide necessary services promptly. It maintains real-time visibility into medical facility operations and nursing home availability to establish rapid emergency response systems. In areas with many child-rearing families, the placement of childcare facilities and schools is optimized to enhance the educational environment. Plans are formulated to install pedestrian bridges over high-traffic roads to ensure the safety of school routes. Data is provided to plan the expansion or reduction of public infrastructure in response to population growth or decline.

### Step 3: Traffic Data Monitoring and Forecasting

The Traffic Data Analysis Department monitors traffic conditions in real time and forecasts traffic volume fluctuations. This step utilizes data from traffic sensors and cameras to optimize public transportation schedules. It increases the frequency of buses and trains during commuting hours to alleviate traffic congestion. Based on passenger volume data, it increases the number of departures during peak demand periods. During events, temporary traffic routes are established to ensure smooth pedestrian flow. For large-scale sporting events, plans are formulated to implement traffic restrictions around venues and operate shuttle buses. Preventive measures are devised to reduce the risk of traffic accidents and enhance traffic safety. This includes installing road signs at accident-prone locations and reviewing speed limits.

### Step 4: Energy Consumption Management

The Energy Management Department collects citywide energy consumption data and develops plans to achieve efficient energy use. This step focuses on introducing renewable energy and shifting energy consumption away from peak times. Plans for installing solar and wind power generation systems will be developed, aiming for energy self-sufficiency. Analyze regional sunlight hours and wind condition data to propose optimal placement of power generation facilities. During peak energy consumption periods, provide incentives to level demand and promote efficient energy use. Implement programs offering electricity rate discounts to households that reduce power consumption during peak times. Provide data to support the design and renovation of energy-efficient buildings. Promote the use of highly insulating building materials to improve building energy efficiency.

### Step 5: Environmental Data Monitoring

The Environmental Monitoring Department monitors the city's environmental data in real time and implements measures for environmental protection. This step involves early detection of air pollution and noise issues and taking appropriate countermeasures. Plans are formulated for installing air purifiers and expanding green spaces to improve the urban environment. PM 2.5 and NOx concentration data to identify pollution sources and implement countermeasures. It provides residents with Environmental information is provided to residents to promote environmental awareness. Real-time environmental data is delivered via smartphone apps, encouraging residents to reconsider their own actions. Support is provided for urban planning addressing climate change, aiming to realize sustainable cities. Drainage systems are reinforced in flood-risk areas, and greenery is used to mitigate the heat island effect.

### Step 6: Data Analysis Using Generative AI

Use generative AI to analyze various data sets. In this step, feed the generative AI prompts such as prompts such as "Propose optimal public transportation routes based on urban traffic data" or "Analyze energy consumption data and formulate a renewable energy implementation plan." This enables the AI to efficiently analyze data and support optimal urban planning. The AI integrates geographic information, demographic data, traffic data, energy consumption data, and environmental data for comprehensive analysis, providing insights to optimize urban functions.

### Specific Use Cases

For example, when implementing a smart city project in a major metropolitan area aimed at alleviating traffic congestion and improving energy efficiency, the system of the present invention functions as follows. The geographic information acquisition unit collects and analyzes topographical data and infrastructure information for the entire city. This unit identifies intersections prone to traffic congestion using data from traffic sensors and cameras, and optimizes signal control. Specifically, it analyzes traffic flow during specific time periods and adjusts signal timing to smooth traffic flow. It also proposes optimal layouts for new roads and public transportation routes, considering topography and existing infrastructure.

The Population Dynamics Analysis Department analyzes population density, age demographics, and lifestyle patterns by region. This department identifies residents' movement patterns and daily activity times to forecast demand for public services. For example, in areas with a high elderly population, it optimizes the placement of nursing care facilities and medical institutions to provide necessary services promptly. In areas with many families raising children, it optimizes the placement of childcare facilities and schools to enhance the educational environment.

The Traffic Data Analysis Department monitors traffic conditions in real time and forecasts traffic volume fluctuations. This department increases the frequency of bus and train services during commuting hours to alleviate traffic congestion. Specifically, based on passenger volume data, it increases the number of departures during peak demand periods. Furthermore, during events, it establishes temporary traffic routes to ensure smooth pedestrian flow.

The Energy Management Department collects citywide energy consumption data and develops plans to achieve efficient energy use. This department promotes the adoption of renewable energy and shifts energy consumption away from peak times. For example, it develops plans to introduce solar and wind power generation, aiming for energy self-sufficiency. It analyzes regional sunlight hours and wind condition data to propose optimal placements for power generation facilities.

The Environmental Monitoring Department monitors the city's environmental data in real time and implements measures for environmental protection. This department detects air pollution and noise issues early and takes appropriate countermeasures. For example, we will formulate plans to install air purifiers and expand green spaces to improve the urban environment. We will analyze PM 2.5 and NOx concentration data to identify pollution sources and implement countermeasures.

In the step utilizing generative AI, prompt sentences such as "Propose optimal public transportation routes based on urban traffic data" or "Analyze energy consumption data and formulate a renewable energy introduction plan" are fed to the generative AI. This enables the AI to efficiently analyze data and support optimal urban planning. The AI provides insights to optimize urban functions by comprehensively analyzing geographic information, demographic data, traffic data, energy consumption data, and environmental data.

The specific processing unit 290 transmits the results of the specific processing to the smart device 14. On the smart device 14, the control unit 46A instructs the output device 40 to output the results of the specific processing. The microphone 38B acquires audio indicating user input regarding the results of the specific processing. The control unit 46A transmits the audio data indicating the user input acquired by the microphone 38B to the data processing unit 12. At the data processing unit 12, the specific processing unit 290 acquires the audio data.

The data generation model 58 is a so-called generative AI (Artificial Intelligence). An example of the data generation model 58 is ChatGPT (registered trademark) (Internet search <URL: https://openai.com/blog/chatgpt>). The data generation model 58 is obtained by performing deep learning on a neural network. The data generation model 58 receives input of a prompt containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats, such as audio data, text data, and image data. The data generation model 58 includes, for example, text generation AI, image generation AI, and multimodal generation AI. Here, inference refers to, for example, analysis, classification, prediction, and/or summarization. The specific processing unit 290 performs the aforementioned specific processing while utilizing the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others. The AI may perform various processing operations, but is not limited to such examples. Furthermore, the AI may be an AI agent. Also, when the processing of the aforementioned parts is performed by AI, that processing may be performed in part or in whole by AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the acquisition unit is implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12, but the technology disclosed herein is not limited thereto; specific processing may also be performed by the smart device 14.

### SECOND EMBODIMENT

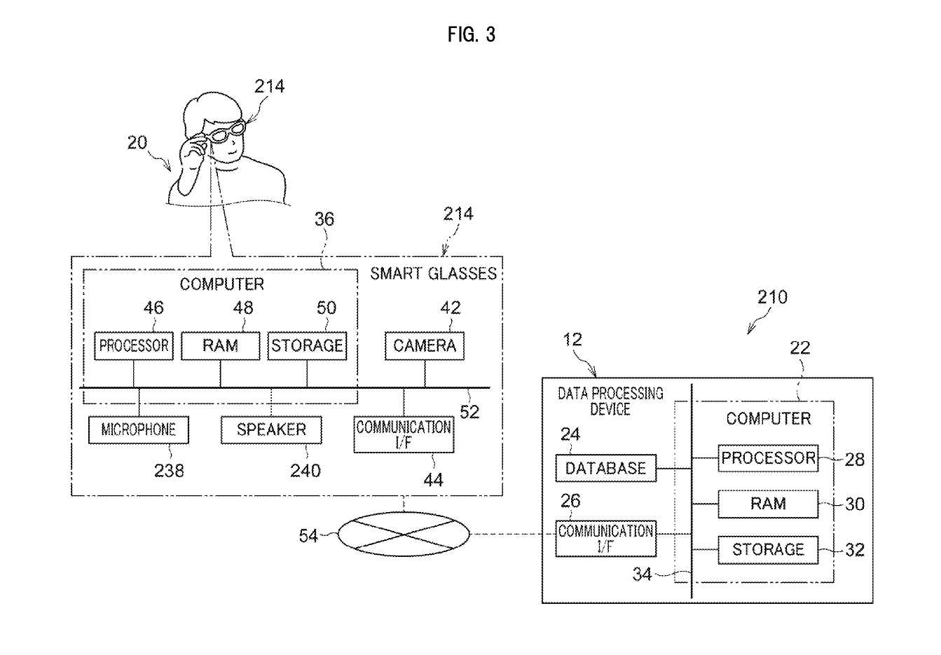

FIG. 3 shows an example configuration of the data processing system 210 according to the second embodiment.

As shown in FIG. 3, the data processing system 210 includes a data processing device 12 and smart glasses 214. An example of the data processing device 12 is a server.

The data processing device 12 includes a computer 22, a database 24, and a communication I/F 26. The computer 22 is an example of a "computer" according to the technology of the present disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 include a WAN (Wide Area Network) and/or a LAN (Local Area Network).

The smart glasses 214 include a computer 36, a microphone 238, a speaker 240, a camera 42, and a communication I/F 44. The computer 36 includes a processor 360, a memory 361, and a communication I/F 44. The computer 36 includes a processor 46, RAM 48, and storage 50. Processor 46, RAM 48, and storage 50 are connected to bus 52. Microphone 238, speaker 240, and camera 42 are also connected to bus 52.

Microphone 238 receives voice input from user 20 to accept instructions or other commands. Microphone 238 captures the voice input from user 20, converts the captured voice into audio data, and outputs it to processor 46. Speaker 240 outputs audio in accordance with instructions from processor 46.

The camera 42 is a compact digital camera equipped with an optical system, such as a lens, aperture, and shutter, and an imaging element, such as a CMOS (Complementary Metal-Oxide-Semiconductor) image sensor or a CCD (Charge Coupled Device) image sensor. It captures images of the user's surroundings (e.g., an imaging range defined by a field of view equivalent to that of a typical healthy person).

The communication I/F 44 is connected to the network 54. The communication I/Fs 44 and 26 manage the exchange of various information between processor 46 and processor 28 via network 54. The exchange of various information between processor 46 and processor 28 using communication I/F 44 and 26 is performed in a secure state.

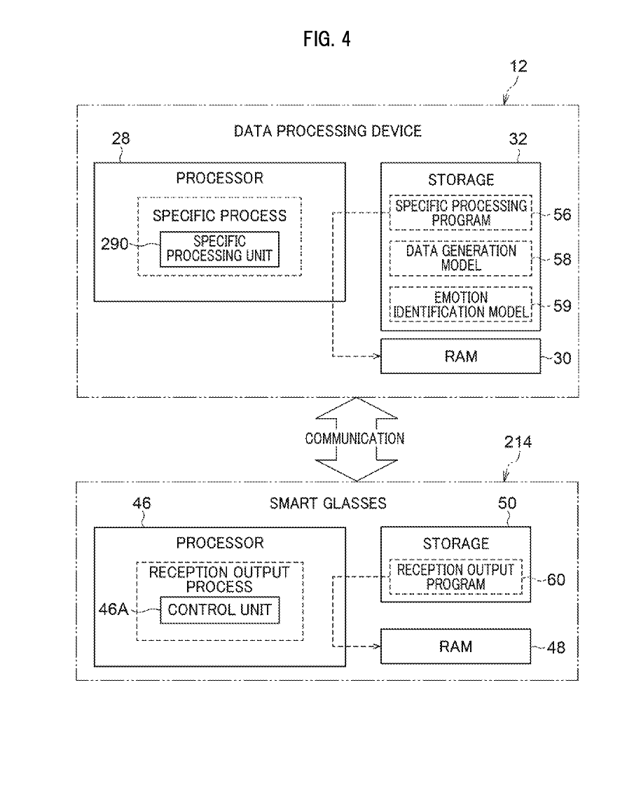

FIG. 4 shows an example of key functions of the data processing device 12 and the smart glasses 214. As shown in FIG. 4, specific processing is performed by the processor 28 in the data processing device 12. The specific processing program 56 is stored in the storage 32.

The specific processing program 56 is an example of a "program" related to the technology of this disclosure. Processor 28 reads the specific processing program 56 from storage 32 and executes the read specific processing program 56 on RAM 30. The specific processing is realized by processor 28 operating as specific processing unit 290 according to the specific processing program 56 executed on RAM 30.

Storage 32 stores a data generation model 58 and an emotion identification model 59. The data generation model 58 and emotion identification model 59 are used by specific processing unit 290. Specific processing unit 290 can estimate a user's emotion using emotion identification model 59 and perform specific processing using the user's emotion. The emotion estimation function (emotion identification function) using the emotion identification model 59 performs various estimations and predictions concerning the user's emotion, including estimation and prediction of the user's emotion, but is not limited to such examples. Furthermore, estimation and prediction of emotion also includes, for example, analysis (parsing) of emotion.

In the smart glasses 214, the processor 46 performs the reception output processing. The reception output program 60 is stored in the storage 50. The processor 46 reads the reception output program 60 from the storage 50 and executes the read reception output program 60 on the RAM 48. The reception output processing is realized by the processor 46 operating as the control unit 46A according to the reception output program 60 executed on the RAM 48. The reception output processing is performed by the processor 46 acting as a control unit 46A according to the reception output program 60 executed on RAM 48. Note that the smart glasses 214 may also have a data generation model 58 and an emotion identification model 59, and can perform processing similar to that of the identification processing unit 290 using these models.

Next, we describe the specific processing performed by the specific processing unit 290 of the data processing device 12. The components of the system described below are implemented by the data processing device 12 and the smart glasses 214. In the following description, the data processing device 12 is referred to as the "server," and the smart glasses 214 are referred to as the "terminal."

### Example 1

The flow of the specific processing is the same as that described in Example 1 of the first embodiment, so the explanation is omitted.

### Application Example 1

The flow of the specific processing in Example 1 described in the first embodiment is the same as above, so the explanation is omitted.

The specific processing unit 290 transmits the result of the specific processing to the smart glasses 214. In the smart glasses 214, the control unit 46A causes the speaker 240 to output the result of the specific processing. The microphone 238 acquires audio indicating user input regarding the result of the specific processing. The control unit 46A transmits the audio data indicating the user input acquired by the microphone 238 to the data processing device 12. At the data processing device 12, the specific processing unit 290 acquires the audio data.

The data generation model 58 is a so-called generative AI (Artificial Intelligence). An example of the data generation model 58 is ChatGPT (registered trademark) (Internet search <URL: https://openai.com/blog/chatgpt>). The data generation model 58 is obtained by performing deep learning on a neural network. The data generation model 58 receives input of a prompt containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats, such as audio data, text data, and image data. The data generation model 58 includes, for example, text generation AI, image generation AI, and multimodal generation AI. Here, inference refers to, for example, analysis, classification, prediction, and/or summarization. The specific processing unit 290 performs the aforementioned specific processing while utilizing the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58. The data generation model 58 includes AI other than generative AI. AI other than generative AI includes, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others. The AI may perform various processing operations, but is not limited to such examples. Furthermore, the AI may be an AI agent. Also, when the processing of the aforementioned components is performed by AI, that processing may be performed in part or in whole by AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit may acquire step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using the generation AI. For example, the provision unit is implemented by the output device 40 of the smart device 14 or the specific processing unit 290 of the data processing device 12 and provides the generated cooking menu to the user. The correspondence between each unit and the device or control unit is not limited to the examples described above and can be modified in various ways.

The above embodiment described a form where specific processing is performed by the data processing device 12, but the technology disclosed herein is not limited thereto; specific processing may also be performed by the smart glasses 214.

### THIRD EMBODIMENT

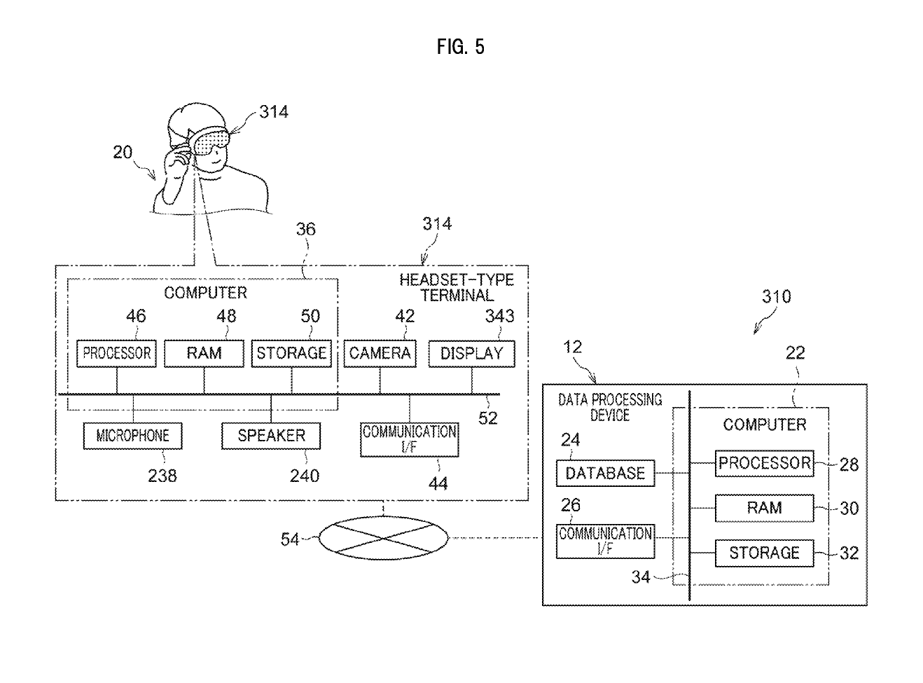

FIG. 5 shows an example configuration of the data processing system 310 according to the third embodiment.

As shown in FIG. 5, the data processing system 310 includes a data processing device 12 and a headset-type terminal 314. An example of the data processing device 12 is a server.

The data processing device 12 includes a computer 22, a database 24, and a communication I/F 26. The computer 22 is an example of a "computer" according to the technology of the present disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 include a WAN (Wide Area Network) and/or a LAN (Local Area Network).

The headset-type terminal 314 comprises a computer 36, a microphone 238, a speaker 240, a camera 42, a communication interface 44, and a display 343. The computer 36 includes a processor 46, RAM 48, and storage 50. The processor 46, RAM 48, and storage 50 are connected to a bus 52. The microphone 238, speaker 240, camera 42, and display 343 are also connected to the bus 52.

Microphone 238 receives voice input from user 20 to accept instructions or other commands. Microphone 238 captures the voice input from user 20, converts the captured voice into audio data, and outputs it to processor 46. Speaker 240 outputs audio in accordance with instructions from processor 46.

The camera 42 is a compact digital camera equipped with an optical system, such as a lens, aperture, and shutter, and an imaging element, such as a CMOS (Complementary Metal-Oxide-Semiconductor) image sensor or a CCD (Charge Coupled Device) image sensor. It captures images of the user's surroundings (e.g., an imaging range defined by a field of view equivalent to that of a typical healthy person).

The communication I/F 44 is connected to the network 54. The communication I/Fs 44 and 26 manage the exchange of various information between processor 46 and processor 28 via network 54. The exchange of various information between processor 46 and processor 28 using communication I/F 44 and 26 is performed in a secure state.

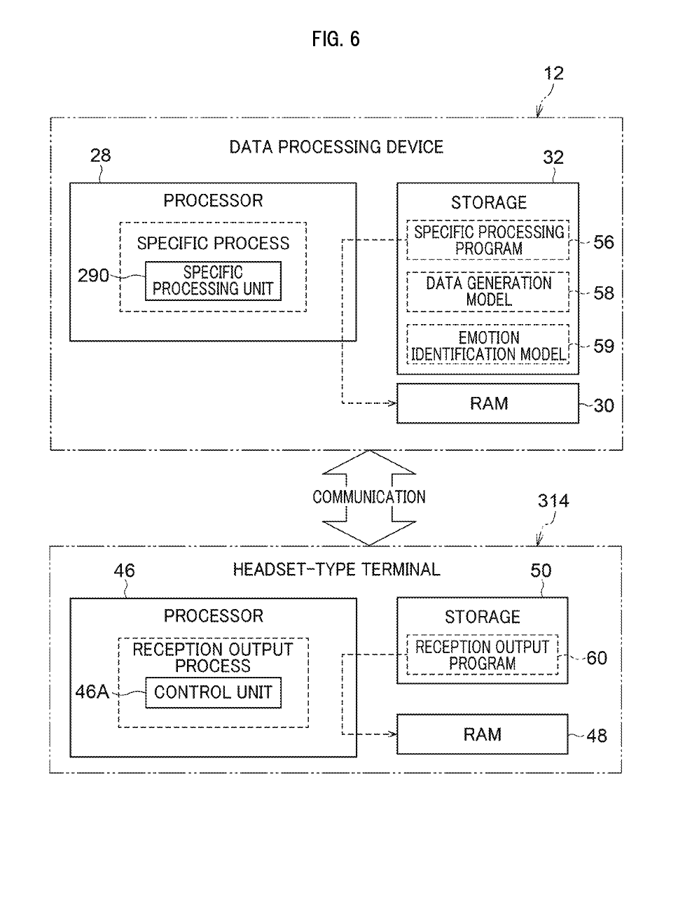

FIG. 6 shows an example of the main functions of the data processing device 12 and the headset-type terminal 314. As shown in FIG. 6, specific processing is performed by the processor 28 in the data processing device 12. The specific processing program 56 is stored in the storage 32.

The specific processing program 56 is an example of a "program" related to the technology of this disclosure. The processor 28 reads the specific processing program 56 from the storage 32 and executes the read specific processing program 56 on the RAM 30. The specific processing is realized by the processor 28 operating as a specific processing unit 290 according to the specific processing program 56 executed on the RAM 30.

Storage 32 stores a data generation model 58 and an emotion identification model 59. The data generation model 58 and the emotion identification model 59 are used by the specific processing unit 290.

In the headset-type terminal 314, reception output processing is performed by the processor 46. The reception output program 60 is stored in the storage 50. The processor 46 reads the reception output program 60 from the storage 50 and executes the read reception output program 60 on the RAM 48. The reception output processing is realized by the processor 46 operating as a control unit 46A according to the reception output program 60 executed on the RAM 48.

Next, the specific processing performed by the specific processing unit 290 of the data processing device 12 is described. The various parts of the system described below are implemented by the data processing device 12 and the headset-type terminal 314. In the following description, the data processing device 12 is referred to as the "server," and the headset-type terminal 314 is referred to as the "terminal."

### Example 1

The flow of the specific processing is the same as that described in Example 1 of the first embodiment, so the description is omitted.

### Application Example 1

The flow of the specific processing in Example 1 described in the first embodiment is the same as above, so the explanation is omitted.

The specific processing unit 290 transmits the result of the specific processing to the headset-type terminal 314. At the headset-type terminal 314, the control unit 46A causes the speaker 240 and the display 343 to output the result of the specific processing. The microphone 238 acquires audio indicating user input regarding the result of the specific processing. The control unit 46A transmits the audio data indicating the user input acquired by the microphone 238 to the data processing device 12. At the data processing device 12, the specific processing unit 290 acquires the audio data.

Data Generation Model 58 is a so-called generative AI (Artificial Intelligence). An example of a data generation model 58 is ChatGPT (registered trademark) (Internet search <URL: https://openai.com/blog/chatgpt>). Data generation model 58 is obtained by performing deep learning on a neural network. Data generation model 58 receives input prompts containing instructions, as well as inference data such as audio data representing sound, text data representing text, and image data (e.g., still image data or video data) representing images. Data generation model 58 infers based on the input inference data according to the instructions indicated by the prompt and outputs the inference result in one or more of the data formats such as audio data, text data, and image data. The data generation model 58 may include, for example, text generation AI, image generation AI, multimodal generation AI, etc. Here, inference refers to, for example, analysis, classification, prediction, and/or summarization. The specific processing unit 290 performs the specific processing described above using the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others. The AI may perform various processing operations, but is not limited to such examples. Furthermore, the AI may be an AI agent. Also, when the processing of the aforementioned components is performed by AI, that processing may be performed in part or in whole by AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12, but the technology disclosed herein is not limited thereto; specific processing may also be performed by the headset-type terminal 314.

### FOURTH EMBODIMENT

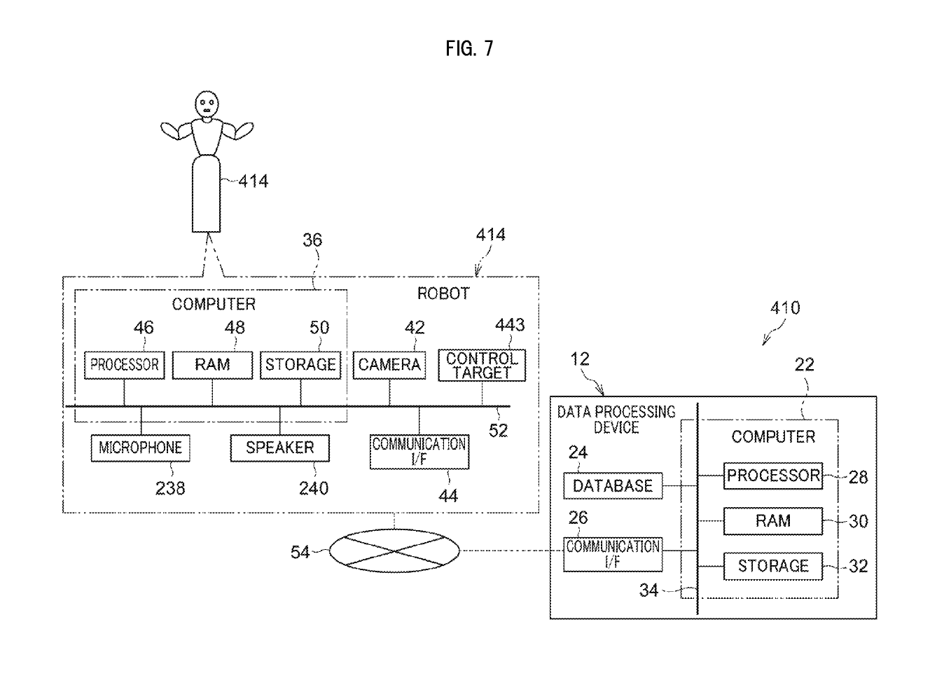

FIG. 7 shows an example configuration of the data processing system 410 according to the fourth embodiment.

As shown in FIG. 7, the data processing system 410 includes a data processing device 12 and a robot 414. An example of the data processing device 12 is a server.

The data processing device 12 includes a computer 22, a database 24, and a communication I/F 26. The computer 22 is an example of a "computer" related to the technology of this disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 is WAN (Wide Area Network) and/or LAN (Local Area Network) are examples.

Robot 414 includes a computer 36, a microphone 238, a speaker 240, a camera 42, a communication I/F 44, and a control target 443. Computer 36 includes a processor 46, RAM 48, and storage 50. Processor 46, RAM 48, and storage 50 are connected to bus 52. Furthermore, microphone 238, speaker 240, camera 42, and controlled object 443 are also connected to bus 52.

Microphone 238 receives voice commands from user 20 by capturing the voice emitted by user 20. Microphone 238 captures the voice emitted by user 20, converts the captured voice into voice data, and outputs it to processor 46. Speaker 240 outputs voice according to instructions from processor 46.

Camera 42 is a compact digital camera equipped with an optical system, such as a lens, aperture, and shutter, and an imaging element, such as a CMOS (Complementary Metal-Oxide-Semiconductor) image sensor or a CCD (Charge Coupled Device) image sensor. It captures images of the user's surroundings (e.g., an imaging range defined by a field of view equivalent to that of a typical healthy person).

The communication I/F 44 is connected to the network 54. The communication I/Fs 44 and 26 manage the exchange of various information between processor 46 and processor 28 via network 54. The exchange of various information between processor 46 and processor 28 using communication I/F 44 and 26 is performed in a secure state.

The control target 443 includes a display device, LEDs for the eye section, and motors for driving the arms, hands, legs, etc. The posture and gestures of robot 414 are controlled by controlling the motors for the arms, hands, legs, etc. Part of the robot 414's emotions can be expressed by controlling these motors. Furthermore, the robot 414's facial expressions can also be expressed by controlling the light emission state of the LEDs in its eyes.

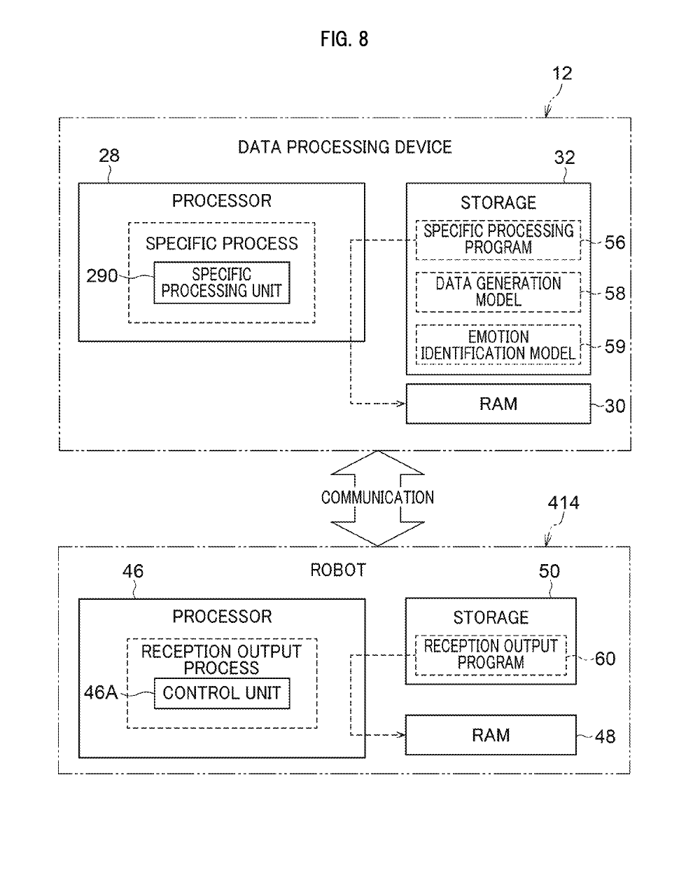

FIG. 8 shows an example of the main functions of the data processing device 12 and the robot 414. As shown in FIG. 8, specific processing is performed by the processor 28 in the data processing device 12. The specific processing program 56 is stored in the storage 32.

The specific processing program 56 is an example of a "program" pertaining to the technology of this disclosure. The processor 28 reads the specific processing program 56 from the storage 32 and executes the read specific processing program 56 on the RAM 30. The specific processing is realized by the processor 28 operating as a specific processing unit 290 according to the specific processing program 56 executed on the RAM 30.

Storage 32 stores a data generation model 58 and an emotion identification model 59. The data generation model 58 and the emotion identification model 59 are used by specific processing unit 290.

In robot 414, reception output processing is performed by processor 46. Storage 50 stores a reception output program 60. Processor 46 reads the reception output program 60 from storage 50 and executes the read reception output program 60 on RAM 48. Reception output processing is realized by the processor 46 operating as a control unit 46A according to the reception output program 60 executed on RAM 48.

Next, the specific processing performed by the specific processing unit 290 of the data processing device 12 is described. The various parts of the system described below are realized by the data processing device 12 and the robot 414. In the following description, the data processing device 12 is referred to as the "server," and the robot 414 is referred to as the "terminal."

### Example 1

The flow of the specific processing is the same as that described in Example 1 of the first embodiment, so the description is omitted.

### Application Example 1

The flow of the specific processing in Example 1 described in the above first embodiment is the same, so the explanation is omitted.

The specific processing unit 290 transmits the result of the specific processing to the robot 414. In the robot 414, the control unit 46A causes the speaker 240 and the control target 443 to output the result of the specific processing. The microphone 238 acquires audio indicating user input regarding the result of the specific processing. The control unit 46A transmits the audio data indicating the user input acquired by the microphone 238 to the data processing device 12. At the data processing device 12, the specific processing unit 290 acquires the audio data.

Data Generation Model 58 is what is known as generative AI (Artificial Intelligence). An example of a data generation model 58 is ChatGPT (registered trademark) (Internet search <URL: https://openai.com/blog/chatgpt>). Data generation model 58 is obtained by performing deep learning on a neural network. Data generation model 58 receives input of a prompt containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats, such as audio data, text data, and image data. The data generation model 58 includes, for example, text generation AI, image generation AI, and multimodal generation AI. Here, inference refers to, for example, analysis, classification, prediction, and/or summarization. The specific processing unit 290 performs the aforementioned specific processing while utilizing the data generation model 58. The data generation model 58 may be a fine-tuned model capable of outputting inference results from prompts that do not contain instructions. In this case, the data generation model 58 can output inference results from prompts that do not contain instructions. The data processing device 12 and the like include multiple types of data generation models 58, and the data generation model 58 includes AI other than generative AI. AI other than generative AI includes, for example, linear regression, logistic regression, decision trees, random forests, support vector machines (SVM), k-means clustering, convolutional neural networks (CNNs), recurrent neural networks (RNN), generative adversarial networks (GAN), or naive Bayes, among others. The AI may perform various processing operations, but is not limited to such examples. AI may also be an AI agent. Furthermore, when processing by the aforementioned components is performed by AI, such processing may be performed in part or in whole by AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12, but the technology disclosed herein is not limited thereto; specific processing may also be performed by the robot 414.

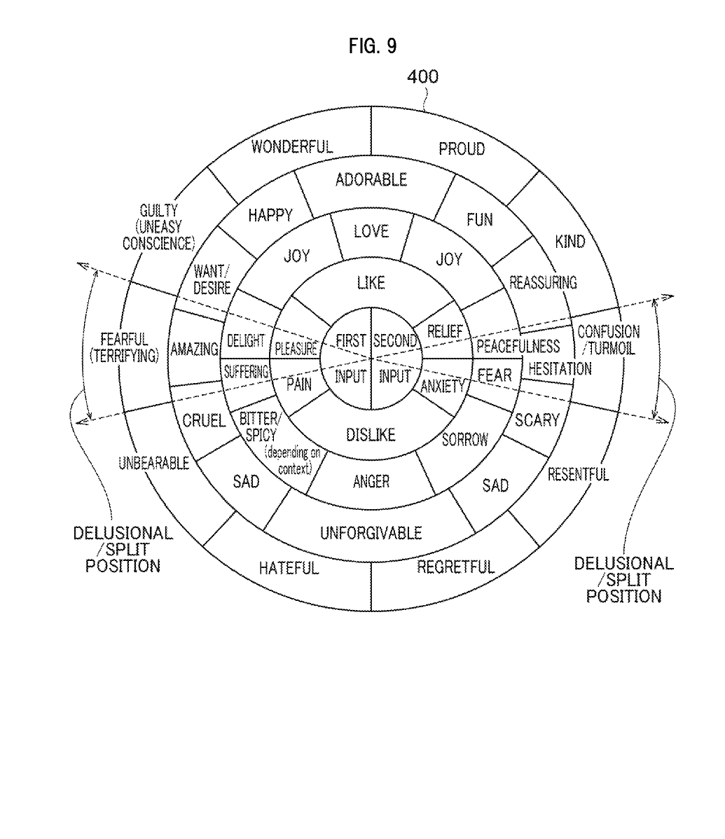

The emotion identification model 59, functioning as an emotion engine, may determine the user's emotion according to a specific mapping. Specifically, the emotion identification model 59 may determine the user's emotion according to an emotion map (see FIG. 9), which is a specific mapping. Furthermore, the emotion identification model 59 may similarly determine the robot's emotion, and the specific processing unit 290 may perform specific processing using the robot's emotion.

FIG. 9 is a diagram showing an emotion map 400 where multiple emotions are mapped. In the emotion map 400, emotions are arranged in concentric circles radiating from the center. Emotions closer to the center of the concentric circles represent more primitive states. Emotions representing states or behaviors arising from mental states are placed further out in the concentric circles. Emotion is a concept encompassing affect and mental states. Generally, emotions generated from reactions occurring within the brain are placed on the left side of the concentric circles. Generally, emotions induced by situational judgment are placed on the right side of the concentric circles. Generally, emotions generated from reactions occurring within the brain and also induced by situational judgment are placed in the upper and lower directions of the concentric circles. Furthermore, the upper part of the concentric circle contains "pleasant" emotions, while the lower part contains "unpleasant" emotions. Thus, the Emotion Map 400 maps multiple emotions based on the structure of their origin, with emotions that tend to occur simultaneously mapped close together.

These emotions are distributed around the 3 o'clock position on Emotion Map 400, typically oscillating between feelings of security and anxiety. In the right half of Emotion Map 400, situational awareness takes precedence over internal sensations, resulting in a calmer impression.

The inner part of the emotion map 400 represents the mind, while the outer part represents behavior. Therefore, the further out on the emotion map 400, the more visible the emotion becomes (manifesting in behavior).

Here, human emotions are based on various balances, such as posture and blood sugar levels. When these balances deviate from the ideal, it indicates a state of discomfort; when they approach the ideal, it indicates a state of comfort. Similarly, for robots, automobiles, motorcycles, etc., emotions can be created based on various balances, such as posture and battery level. When these balances deviate from the ideal, it indicates a state of discomfort; when they approach the ideal, it indicates a state of comfort. Emotion maps, for example, Dr. Mitsuyoshi's Emotion Map (Based on research on speech emotion recognition and neurophysiological signal analysis of emotions, Tokushima University, Doctoral Dissertation: https://ci.nii.ac.jp/naid/500000375379). The left half of the emotion map displays emotions belonging to the "Reaction" domain, where sensory aspects predominate. The right half of the emotion map displays emotions belonging to the "Situation" domain, where situational awareness is dominant.

The emotion map defines two emotions that promote learning. One is the negative emotion around the center of the "repentance" or "reflection" area on the situation side. That is, when the robot experiences negative emotions like "I never want to feel this way again" or "I don't want to be scolded anymore." The other is the positive emotion around "desire" on the reaction side. That is, when the robot feels positive emotions like "I want more" or "I want to know more."

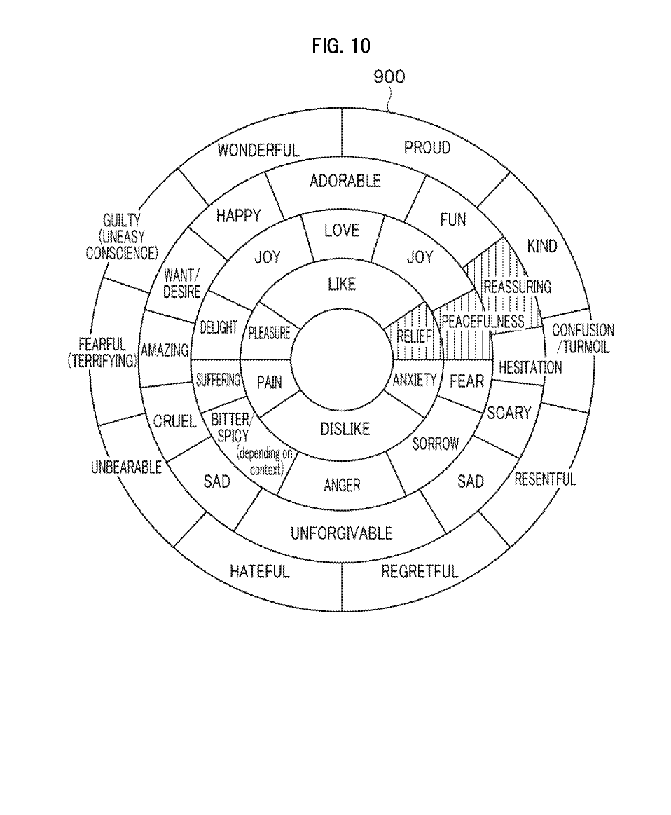

The emotion identification model 59 inputs the user input into a pre-trained neural network, obtains emotion values corresponding to each emotion shown in the emotion map 400, and determines the user's emotion. This neural network is pre-trained based on multiple training data sets, which are combinations of user input and emotion values corresponding to each emotion shown in the emotion map 400. Furthermore, this neural network is trained such that emotions positioned close to each other, as shown in the emotion map 900 in FIG. 10, have similar values. FIG. 10 illustrates an example where multiple emotions, such as "reassurance," "tranquility," and "encouragement," have similar emotion values.

The above description primarily explains the system according to the present disclosure in terms of the functions of the data processing device 12. However, the system according to the present disclosure is not necessarily implemented on a server. The system according to the present disclosure may be implemented as a general information processing system. For example, the present disclosure may be implemented as a software program operating on a personal computer or as an application operating on a smartphone, etc. The method according to the present disclosure may be provided to users in a SaaS (Software as a Service) format.

The above embodiment illustrated an example configuration where specific processing is performed by a single computer 22. However, the technology of this disclosure is not limited thereto. Distributed processing may be performed by multiple computers, including computer 22, for specific processing. For example, data generation model 58 may be provided on an external device of data processing device 12, and said external device may generate data corresponding to input data. For example, the data generation model 58 may be provided in an external device of the data processing device 12, and data generation corresponding to input data may be performed in said external device.

The above embodiment described a configuration where the specific processing program 56 is stored in the storage 32. However, the technology disclosed herein is not limited to this. For example, the specific processing program 56 may be stored on a portable, computer-readable non-volatile storage medium, such as a USB (Universal Serial Bus) memory. The specific processing program 56 stored on the non-volatile storage medium is installed on the computer 22 of the data processing device 12. The processor 28 executes specific processing according to the specific processing program 56.

Alternatively, the specific processing program 56 may be stored on a storage device, such as a server, connected to the data processing device 12 via the network 54. Upon request from the data processing device 12, the specific processing program 56 is downloaded and installed on the computer 22.

It should be noted that it is not necessary to store the entire specific processing program 56 on a storage device such as a server connected to the data processing device 12 via the network 54, or to store the entire specific processing program 56 in the storage 32. It is also possible to store only a portion of the specific processing program 56.

Various types of processors can be used as hardware resources to execute the specific processing. Examples of processors include a CPU, which is a general-purpose processor that functions as a hardware resource for executing specific processing by executing software, i.e., a program. Additionally, processors may include dedicated electronic circuits, such as FPGAs (Field-Programmable Gate Array), PLDs (Programmable Logic Device), or ASICs (Application Specific Integrated Circuit), which are processors with circuit configurations specifically designed to execute particular processing tasks. Each processor incorporates or connects to memory, and each processor executes specific processing by utilizing this memory.

The hardware resources for executing specific processing may be comprised of one of these various processors, or may be comprised of a combination of two or more processors of the same or different types (e.g., a combination of multiple FPGAs, or a combination of a CPU and an FPGA). Furthermore, the hardware resources for executing specific processing may be a single processor.

Examples of configurations using a single processor include: First, a configuration where one processor is formed by a combination of one or more CPUs and software, with this processor functioning as the hardware resource executing specific processing. Second, there is a form using a processor that implements the entire system functionality, including multiple hardware resources executing specific processing, on a single IC chip, as exemplified by a System-on-a-chip (SoC). Thus, specific processing is implemented using one or more of the above various processors as hardware resources.

Furthermore, regarding the hardware structure of these various processors, more specifically, electrical circuits combining circuit elements such as semiconductor devices can be used. Also, the specific processing described above is merely one example. Therefore, it goes without saying that within the scope not deviating from the main purpose, unnecessary steps may be omitted, new steps may be added, or the processing order may be changed.

The above description and illustrations provide a detailed explanation of the aspects pertaining to the technology of this disclosure and represent merely one example of the technology disclosed herein. For example, the explanations regarding the configuration, functions, actions, and effects described above are examples of the configuration, functions, actions, and effects pertaining to the aspects of the technology disclosed herein. Therefore, it goes without saying that within the scope of not deviating from the essence of the technology of this disclosure, unnecessary portions may be deleted, new elements may be added, or replacements may be made to the above-described content and illustrated content. Furthermore, to avoid complexity and facilitate understanding of the part pertaining to the technology of this disclosure, descriptions of technical common knowledge, etc., that are particularly unnecessary for enabling the implementation of the technology of this disclosure have been omitted from the above-described content and illustrated content.

All literature, patent applications, and technical standards described herein are incorporated by reference into this specification to the same extent as if each individual literature, patent application, and technical standard were specifically and individually incorporated by reference.

Regarding the above embodiments, the following is further disclosed.

### Supplementary Note 1

A system comprising a geographic information acquisition unit, a population dynamics analysis unit, a traffic data analysis unit, an energy management unit, and an environmental monitoring unit. The geographic information acquisition unit collects urban topography data and infrastructure information, providing foundational data for optimizing urban road networks and public transportation layouts. The population dynamics analysis unit analyzes population density, age groups, and lifestyle patterns by region to predict demand for public services. The traffic data analysis unit monitors traffic conditions in real time, forecasts traffic volume fluctuations, and optimizes public transportation schedules. The energy management unit collects citywide energy consumption data and formulates plans to achieve efficient energy utilization. The environmental monitoring unit monitors city environmental data in real time and implements measures for environmental protection.

A system as described in Supplementary Note 1, wherein the Geographic Information Acquisition Department has the function of analyzing detailed data on the city's topography and infrastructure to provide foundational data for optimizing traffic flow and the placement of public facilities. This enables the identification of areas prone to traffic congestion, allowing for the planning of traffic signal control and road expansion. Furthermore, it enables the proposal of optimal layouts for new roads and public transportation routes, taking into account topography and existing infrastructure.

The system described in Supplementary Note 1, wherein the Energy Management Unit analyzes citywide energy consumption data and possesses the function of formulating plans for introducing renewable energy and shifting energy consumption peaks. This enables the formulation of plans for introducing solar and wind power generation, aiming for energy self-sufficiency. Furthermore, during peak energy consumption periods, it can provide incentives to level demand, promoting efficient energy use.

### EXPLANATION OF SYMBOLS

10, 210, 310, 410 Data Processing System

12 Data Processing Device

14 Smart Device

214 Smart Glasses

314 Headset-Type Devices

414 Robot

What is claimed is:

1. A communication network management system, comprising:
a network management server comprising at least one processor, at least one memory storing instructions, a database, and a communication interface coupled to a packet network; and
a plurality of base station facilities each comprising:
base station equipment and/or relay station equipment,
a plurality of sensors configured to measure equipment status telemetry including at least temperature, humidity, power consumption, and operational status, and
a monitoring terminal comprising a terminal processor, a terminal memory, and a terminal communication interface, the monitoring terminal being installed at the base station facility and coupled to the sensors;
wherein the instructions, when executed by the at least one processor of the network management server, cause the network management server to:
acquire geographic information for a target region from at least one geographic information system, satellite data source, or map database, the geographic information including terrain characteristics data and infrastructure layout data;
acquire demographic data for the target region including at least population density data and time-varying population distribution data;
acquire urban planning information including planned development and infrastructure improvement information;
analyze historical communication traffic logs to generate a predicted peak communication demand for the target region;
generate an equipment deployment plan specifying placement and capacity for one or more base stations and/or relay stations by performing an integrated analysis of the geographic information, the demographic data, the urban planning information, and the predicted peak communication demand;
receive, from the monitoring terminals, real-time or near-real-time equipment status telemetry;
determine a learned baseline for the equipment status telemetry using historical telemetry stored in the database;
detect, based on comparison of the equipment status telemetry to the learned baseline, a precursor condition indicating impending equipment failure or aging; and
responsive to detecting the precursor condition, transmit a remote corrective control command to the monitoring terminal to initiate a corrective operation including at least one of a remote reboot or an automatic configuration correction,
whereby communication service continuity and network resource allocation efficiency are improved.

2. The system of claim 1, wherein the terrain characteristics data includes at least one of terrain elevation differences or vegetation density, and the infrastructure layout data includes at least one of road layout data, railway layout data, or building height and configuration data used to reduce radio wave reflection, obstruction, or shielding when generating the equipment deployment plan.

3. The system of claim 1, wherein the time-varying population distribution data includes at least one of:
a daytime population distribution for business districts,
a nighttime population distribution for residential areas, or
a seasonal or event-driven population fluctuation for tourist areas, and
wherein the predicted peak communication demand is generated based on at least one of the daytime and nighttime distributions or the seasonal or event-driven fluctuation.

4. The system of claim 1, wherein the urban planning information includes at least one of a new residential development plan, a new commercial or public facility construction plan, an urban redevelopment plan, or a public transit expansion plan, and wherein generating the equipment deployment plan includes planning base station additions or capacity increases in anticipation of the urban planning information.

5. The system of claim 1, wherein analyzing the historical communication traffic logs includes identifying at least one of a temporary demand surge associated with a scheduled event or a seasonal demand peak, and wherein generating the equipment deployment plan includes planning at least one of additional bandwidth allocation or deployment of temporary relay stations responsive to the temporary demand surge.

6. The system of claim 1, wherein detecting the precursor condition includes performing integrated multivariate analysis across the temperature, humidity, power consumption, and operational status telemetry and comparing the telemetry to historical telemetry stored in the database to detect an abnormal deviation pattern.

7. A computer-implemented method of managing a communication network comprising base station equipment and/or relay station equipment, the method comprising:
acquiring geographic information for a target region including terrain characteristics data and infrastructure layout data;
acquiring demographic data including population density data and time-varying population distribution data;
acquiring urban planning information including planned development and infrastructure improvement information;
analyzing historical communication traffic logs to generate a predicted peak communication demand;
generating an equipment deployment plan specifying placement and capacity for one or more base stations and/or relay stations by performing an integrated analysis of the geographic information, demographic data, urban planning information, and predicted peak communication demand;
receiving real-time or near-real-time equipment status telemetry measured by sensors installed at base station facilities;
determining a learned baseline using historical telemetry stored in a database;
detecting a precursor condition indicating impending failure or aging based on comparison of the telemetry to the learned baseline; and
automatically initiating a corrective operation including at least one of a remote reboot or an automatic configuration correction responsive to detecting the precursor condition.

8. The method of claim 7, wherein generating the equipment deployment plan includes minimizing signal obstruction in an urban area by considering high-rise building heights and configurations and minimizing reflection or obstruction in a mountainous area by analyzing terrain elevation differences and vegetation density.

9. The method of claim 7, wherein analyzing the historical communication traffic logs includes forecasting a surge for a scheduled event and deploying temporary relay stations proximate to an event venue to secure bandwidth.

10. The method of claim 7, wherein generating the equipment deployment plan includes planning dedicated underground relay stations near subway stations based on infrastructure layout data including a subway network structure.

11. The method of claim 7, wherein detecting the precursor condition includes detecting a deviation pattern associated with power consumption exceeding a learned threshold derived from historical telemetry.

12. The method of claim 7, further comprising periodically performing a self-diagnostic check of the base station equipment using a monitoring terminal and logging results in the database.

13. A non-transitory computer-readable medium storing instructions that, when executed by one or more processors of a network management server, cause the network management server to perform operations comprising:
acquiring geographic information including terrain characteristics data and infrastructure layout data;
acquiring demographic data including population density data and time-varying population distribution data;
acquiring urban planning information including planned development and infrastructure improvement information;
analyzing historical communication traffic logs to generate a predicted peak communication demand;
generating an equipment deployment plan specifying placement and capacity for one or more base stations and/or relay stations by performing an integrated analysis of the geographic information, demographic data, urban planning information, and predicted peak communication demand;
receiving real-time or near-real-time equipment status telemetry from monitoring terminals installed at base station facilities;
determining a learned baseline using historical telemetry stored in a database;
detecting a precursor condition indicating impending failure or aging based on comparison of the telemetry to the learned baseline; and
automatically initiating a corrective operation including at least one of a remote reboot or an automatic configuration correction.

14. The non-transitory computer-readable medium of claim 13, wherein the infrastructure layout data includes road and railway layout data used to predict communication demand in high-traffic areas.

15. The non-transitory computer-readable medium of claim 13, wherein the urban planning information includes future residential development plans used to plan base station expansions in anticipation of population growth.

16. The non-transitory computer-readable medium of claim 13, wherein the corrective operation includes instructing a monitoring terminal to automatically reboot the base station equipment to resolve a communication failure caused by a software bug.

17. The non-transitory computer-readable medium of claim 13, wherein the instructions further cause the network management server to store in the database at least equipment status telemetry, learned baseline parameters, detected precursor conditions, and records of corrective operations performed, and to update the learned baseline based on post-correction telemetry.

18. The non-transitory computer-readable medium of claim 13, wherein the instructions further cause the network management server to submit a structured prompt to a generative artificial intelligence model including an instruction to predict regional communication demand using demographic data, and to use output from the generative artificial intelligence model to revise the predicted peak communication demand.
